(19) United States
(12) Patent Application Publication
(10) Pub. No.: US 2009/0048731 A1
(43) Pub. Date: Feb. 19, 2009

(54) Systems And Methods For Unbundling Scheduled Maintenance Operations

(75) Inventors: Donald Levy, Temecula, CA (US); Chad Levy, Temecula, CA (US)

Correspondence Address: FISH & ASSOCIATES, PC;ROBERT D. FISH, 2603 Main Street, Suite 1050, Irvine, CA, 92614-6232, US

(73) Assignee: PRECIS, INC., Escondido, CA (US)

(21) Appl. No.: 12/192,358

(22) Filed: Aug. 15, 2008

Related U.S. Application Data
(60) Provisional application No. 60/956,041, filed on Aug. 15, 2007.

(51) Int. Cl. G06Q 50/00; G06F 19/00; G06Q 10/00

(52) U.S. Cl. 701/30; 705/400

(57) ABSTRACT

A computer system running software operating as a vehicle service advisor is presented. The software on the computer system identifies one or more sets of scheduled maintenance operations for specific vehicles identified by make or build. The sets of the maintenance operations are unbundled into an individual operations that are recombined based on additional factors relating to the vehicles into a recommendation of maintenance operations. An estimate on the cost can be calculated and presented to a customer by correlating specific parts or labor costs with the operations in the recommendation.

This application claims the benefit of priority to U.S. provisional application having Ser. No. 60/956,041 filed on Aug. 15, 2007. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is automotive maintenance.

### BACKGROUND

Automobile dealership Service Departments do not have a practical method of determining prices for individual maintenance operations that are specific to a vehicle's build configuration and driving condition. Automobile Manufacturer's do provide vehicle specific Factory Required Scheduled Maintenance listings (as written in each Vehicle's Owner's Manual), but Automotive Dealerships are owned independently from the Manufacturer and are responsible for determining their own pricing for parts and labor charges. Most Service and Parts Departments are unable to efficiently present their customers with knowledgeable, specific information due to the complexities of the maintenance requirements that are differentiated by the individual vehicle make, model, year, mileage/time increments, vehicle build configuration, and specified driving condition as required by the manufacturer, which render the customer unable to make an informed decision of how to properly maintain their vehicles based on the Owner's Manual Factory Required Scheduled Maintenance.

Therefore, Service and Parts Departments bundle services into general packages and sell them to customers at various mileage intervals. They use “weighted price averaging” to determine various parts prices and offer bundled services to their customers. (Service and Parts Departments of Automotive Dealerships do have knowledge of a few scheduled maintenance items such as oil changes and tire rotations). This widely spread practice is the standard business practice used by most Service and Parts Departments of Franchised Automotive Dealerships. It should be noted, this business practice is illegal in a number of states in the U.S.

The result is that customers are misled and are paying for maintenance and parts that they do not need and in many cases are not offered maintenance items and parts that are required by the Manufacturer to properly maintain their vehicle to keep their warranty on the vehicle in good standing. This has resulted in a lack of trust and confidence between car owners and Service and Parts Departments.

Thus, there is still a need for a practical electronic tool that efficiently and effectively provides Service and Parts Departments with Factory Required Maintenance Schedules with parts and labor pricing that is taken directly from the Owner's Manual like the one that they received with their vehicle.

### SUMMARY OF THE INVENTION

The present invention provides apparatus, systems and methods in which a computer system operates software that recommends sets of unbundled maintenance operations as a function of vehicle make, build, and at least one other factor. Contemplated additional factors include mileage, year mileage/time increments, condition of the vehicle, and expected or historical driving conditions.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a set of functions performed by a computer system that recommends unbundled maintenance operations.

### DETAILED DESCRIPTION

In a preferred embodiment, a computer system is programmed with software to operate as a service advisor where the service advisor performs a plurality of functions to generate a recommendation of maintenance operations. The service advisor can also provide estimates of the cost for the maintenance operations.

A computer system preferably includes hardware, software, or databases working in cooperation to provide a platform for the service advisor. Elements of the computer system can be located locally to a service facility, or remote from the service facility. For example, the service advisor could access a remote database storing suggested maintenance schedules from a manufacturer. The service advisor software running on the computer system can include application software for installation at the facility, or can include web services that could include web pages presented to users. One skilled in the art will recognize there are numerous methods for implementing a computer system that can support the service advisor software without departing from the inventive subject matter.

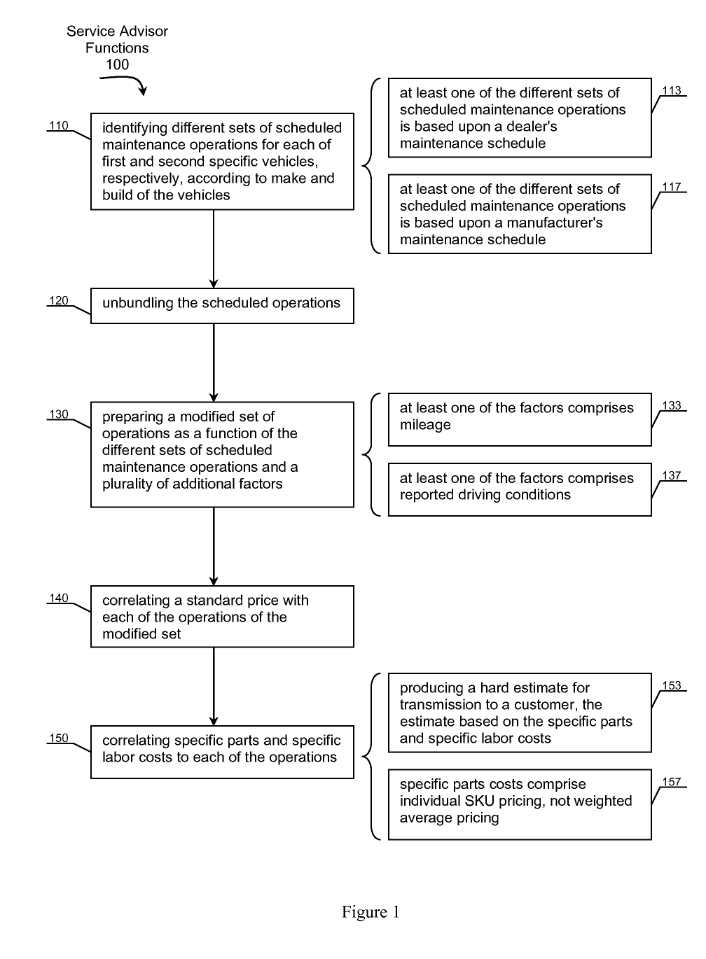

In FIG. 1, software running on the computer system performs one or more of service advisor functions 100. In a preferred embodiment, the service advisor software utilizes information regarding schedule maintenance operations along with factors associated with specific vehicles to generate modified set of operations.

At step 110, a service advisor software can identify different sets of scheduled maintenance operations for specific vehicles. In some embodiments, a user is presented with an interface that lists one or more types of vehicles by make and model. The user can then select at least a first or a second specific vehicle according to the make or model. Upon identifying the type of vehicle, the software can submit a query to a local or a remote database to acquire the scheduled maintenance operations. In a preferred embodiment, the scheduled maintenance operations are based on a dealer's maintenance schedule (step 113) or on a manufacturer's maintenance schedule (step 115).

At step 120, the operations from the schedule maintenance operations are unbundled into one or more individual operations.

At step 130, one or more of the individual operations are combined into a modified set of operations representing a recommendation for the specific vehicles. The individual operations are compared against various factors relating to the specific vehicles for which a recommendation is sought. The modified set of operations is prepared as a function of the schedule maintenance operations as well as factors associated with the specific vehicles. Preferred factors can include mileage (step 133) of the vehicles, or reported driving conditions (step 137). Other factors are also contemplated including special offers, driver demographics (e.g., age, gender, etc. . . . ), owner demographics (e.g., person, corporation, fleet, etc. . . . ), recent unrecorded, yet reported maintenance history, or other attributes.

At step 140, each individual operation that becomes a member of the modified set of operations can be correlated with a standard price. Compiling an itemized list of standard prices provides for establishing an estimate that can be presented to as customer.

At step 150, an estimate can be further refined by correlating specific parts and specific labor costs for each of the individual operations in the modified set of operations. In a preferred embodiment, specific part costs comprise individual SKU pricing as opposed to a weighted average pricing (step 157). In some cases, parts or labor might be excluded because an individual operation has been rendered unnecessary due to reported driving condition, which can reduce the costs to a customer. Additionally, a hard estimate can be calculated from the parts and labor costs. The hard estimate can be produced for transmission or presentation to the customer where the customer has a high degree of confidence that the hard estimate is correct (step 153). The hard estimate can be presented to the customer through a hard printout, an email, a web page, or other presentation means.

It is also contemplated that the principles discussed herein can be applied to other fields in which dealers and others handling maintenance must contend with a multitude of different schedules for different makes and models, and especially where the service packages tend to be bundled.

Thus, specific embodiments and applications for unbundling scheduled maintenance operations have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A computer system that operates software that provides the following functions:
identifying different sets of scheduled maintenance operations for each of first and second specific vehicles, respectively, according to make and build of the vehicles;
unbundling the scheduled operations;
preparing a modified set of operations as a function of the different sets of scheduled maintenance operations and a plurality of additional factors; and
correlating a standard price with each of the operations of the modified set.

2. The computer system of claim 1, wherein at least one of the different sets of scheduled maintenance operations is based upon a manufacturer's maintenance schedule.

3. The computer system of claim 1, wherein at least one of the different sets of scheduled maintenance operations is based upon a dealer's maintenance schedule.

4. The computer system of claim 1, wherein at least one of the factors comprises reported driving conditions.

5. The computer system of claim 1, wherein at least one of the factors comprises mileage.

6. The computer system of claim 1, further comprising correlating specific parts and specific labor costs to each individual operation in the modified set of operations.

7. The computer system of claim 6, further comprising producing a hard estimate for transmission to a customer, the estimate based on the specific parts and specific labor costs.

8. The computer system of claim 6, wherein the specific parts costs comprise individual SKU pricing, not weighted average pricing.
